(19) United States
(12) Patent Application Publication
(10) Pub. No.: US 2015/0373027 A1
(43) Pub. Date: Dec. 24, 2015

(54) MANAGING ACCESS TO A NETWORK

(71) Applicant: LONGSAND LIMITED, Cambridge (GB)

(72) Inventors: Saurabh Gupta, Bangalore (IN); Manjunath Bharadwaj, Bangalore (IN)

(73) Assignee: LONGSAND LIMITED, Cambridge (GB)

(21) Appl. No.: 14/764,994

(22) PCT Filed: Feb. 4, 2013
(86) PCT No.: PCT/IN2013/000076

§ 371 Date: Jul. 31, 2015

(51) Int. Cl. H04L 29/06; H04W 12/08; H04L 29/12

(52) U.S. Cl. CPC H04L 63/102; H04L 61/6022; H04L 61/2015; H04W 12/08

(57) ABSTRACT

An example method for managing access to a network includes presenting, in a user interface of a computer on the network, options to designate by device class, one or more classes of device to which network access will be allowed; and, with a dynamic host configuration protocol (DHCP) server on the network, allowing or denying access to the network based, at least in part, on whether a device requesting access belongs to the one or more classes designated.

### BACKGROUND

A public network is a network established for the specific purpose of providing data transmission services to the public. Client devices, such as desktop computers, laptop computers, smart phones, and tablets enable users to connect to a public network. Once a client device is connected to a public network, a user, for example, may check emails, view web pages, and shop online.

There are billions of client devices in the world trying to connect to public networks all the time. The more client devices connecting to a public network, the more the traffic increases on the public network. Having too many client devices connected to a public network fills the public network to capacity which could overburden the network. If a public network is overburdened, the network experiences congestion and poor performance.

### BRIEF DESCRIPTION OF THE DRAWINGS

The accompanying drawings illustrate various examples of the principles described herein and are a part of the specification. The examples do not limit the scope of the claims.

FIG. 1 is a diagram illustrating a number of classes of client devices connecting to a network, according to one example of principles described herein.

FIG. 2 is a flowchart illustrating a method to manage access to a network, according to one example of principles described herein.

FIG. 3 is a diagram illustrating a method using an Internet Corporation for Assigned Names and Numbers (ICANN) server to manage access to a network, according to one example of principles described herein.

FIG. 4 is a flowchart illustrating a method to manage access to a network, according to one example of principles described herein.

FIG. 5 is a diagram illustrating a method using a server to manage access to a network, according to one example of principles described herein.

FIG. 6 is a flowchart illustrating a method to manage access to a network, according to one example of principles described herein.

Throughout the drawings, identical reference numbers designate similar, but not necessarily identical, elements.

### DETAILED DESCRIPTION

As noted above, the more client devices connecting to a public network, the more the traffic increases on the network. Filling a public network to capacity or overfilling the public network should be avoided by limiting the number of client devices connecting to the network. Limiting the number of client devices connecting to a public network allows legitimate users, such as a network owner or the network owner's employees, clients, customers or associates, to connect to the public network without experiencing congestion and poor performance.

In order to limit the number of client devices connected to a network, a network may rely on such methods as media access control (MAC) filtering. MAC filtering uses a unique 48-bit MAC address that is assigned to a client device's network hardware, such as a network card. A client device's network card is a transceiver used to connect that client device to a network. Once a MAC address has been assigned to a client device's network card, that client device can then be uniquely identifiable amongst all other client devices.

Using the method of MAC filtering to control access to a network, a human user, perhaps a network administrator, manually enters a MAC address for each authorized client device on a white list. A white list is a list or register of MAC addresses of client devices allowed to connect to a network. After a network administrator manually enters a MAC address for each client device on a white list, those client devices can then connect to the network. Consequently, if a MAC address is not manually entered on a white list for a particular client device trying to connect to a network, that client device not on the white list will be prohibited from connecting to the network. Thus, MAC filtering may limit the number of client devices connecting to a network thereby allowing legitimate users to connect to the network without experiencing congestion and poor performance.

As noted, MAC filtering relies on a network administrator manually adding MAC addresses to a white list beforehand to allow client devices to connect to a network. Thus, any new client device not previously added to the white list must be added to the white list before being able to connect to a network. Manually adding client devices to a white list is a burdensome task for network administrators. Further, manually adding client devices to a white list can result in inaccuracies and delays for client devices to connect to a network. Particularly in the case of large networks, network administrators have to add or remove hundreds of client devices on a daily basis.

An alternative approach to MAC filtering is using a password protected network. A password protected network is the most common and simple way of limiting the number of client devices on a network. Using a password protected network, each user is uniquely identified using a username and password. Each user may choose a unique username and password. Alternatively, a user may be assigned a unique username and password, for example, by a network administrator. Only users that have a valid username and password may connect their client device to a network. In such a system, a user is prompted for a username and password before the client device can connect to a network. If the username and password for the network match credentials stored by the network, the client device may connect to the network. Alternatively, if the username and password do not match credentials approved for the network, the client device is prohibited from connecting to the network.

When using a password protected network, setting up a username and password for each user can be a time consuming task. For example, in the case of large networks, network administrators may have to add or remove hundreds of usernames and passwords on a daily basis. Further, if a username and password is compromised and obtained by an unauthorized user, any number of users having that username and password may then connect their client device to the network. As noted above, having too many client devices connected to a network fills the network to capacity which could overburden the network. If a network is over-burdened, the network experiences congestion and poor performance.

The present specification discloses systems and methods to allow only certain classes of client devices to connect to a network. Thus, access to the network is discriminated by the class of a device rather than by individual device credentials. This makes administering access to the network much easier.

In one example devices are classed by manufacturer. Thus, devices from a particular manufacturer may be allowed or denied access to a network based on the device manufacturer. However, any other criteria for dividing devices into authorized and unauthorized device classes that can be determined by the network may be used.

In one example, a method for managing access to a network includes presenting, in a user interface of a computer on the network, options to designate by device class, one or more classes of device to which network access will be allowed; and with a dynamic host configuration protocol (DHCP) server on the network, allowing or denying access to the network based, at least in part, on whether a device requesting access belongs to the one or more classes designated.

This method may also include determining the class of a client device using a dynamic host configuration protocol (DHCP) server to obtain a media access control (MAC) address of the client device; and determining if the MAC address of the client device falls within a range of MAC addresses designated as approved for access to the network. In such an example, the method may allow the client device to connect to the network only if the MAC address of the client device falls within a range of MAC addresses designated as approved for access to the network. Allowing the client device to connect to the network based on the class of the client device includes sending configured information and a usable Internet Protocol (IP) address to the client device. Alternatively, denying access to the network based on the class of the client device comprises sending an internet protocol (IP) address to the client device that leads to a page indicating that access to the network is denied. The present specification also describes a system for receiving, from a server operated by the Internet Corporation for Assigned Names and Numbers (ICANN), a listing of Media Access Control (MAC) addresses that have been assigned to specific device manufacturers; and converting the listing into instructions for a dynamic host configuration protocol (DHCP) server such that the DHCP server matches a MAC address of a device requesting access to a network with a manufacturer of that device to determine a class of that device.

The present specification also describes a system for receiving, from one or more manufacturers of network devices, a listing of Media Access Control (MAC) addresses that have adopted by those manufacturers; and with a dynamic host configuration protocol (DHCP) server, using the listing of MAC addresses to determine a class of a device requesting access to the network.

In these examples, controlling access to a network may be accomplished by determining whether a client device should be given a usable internet protocol (IP) address by a dynamic host configuration protocol (DHCP) server based on a class to which that client device belongs. DHCP is a network protocol that is used to configure client devices so that they can communicate on an internet protocol (IP) network. A DHCP server maintains a database of available IP addresses and configuration information. A client device uses the DHCP protocol to acquire configuration information, such as a usable IP address stored in the IP address database on the DHCP server. The DHCP server uses this information to configure the client device. Once the configuration process is complete, the client device uses the configured information, such as an IP address, to communicate on a network.

To determine if a client device should be given a usable IP address, a user interface of a computer on a network presents options to designate by device class, one or more classes of device to which network access will be allowed. Next, DHCP server on the network determines if a client device requesting access to the network belongs to the one or more classes designated.

To determine if a client device requesting access to the network belongs to the one or more classes designated, a DHCP server obtains the MAC address of the client device when the DHCP server gets a DHCP request. Next, the DHCP server checks the range which the client device's MAC address falls in by comparing the range of MAC addresses used by various manufactures of network hardware and the corresponding consumers of that network hardware. The DHCP server maintains a white list of valid ranges of MAC addresses for a number of classes of client devices allowed to connect to a network based on the manufacturer of that device. Using the above comparison, the DHCP server identifies the class of the client device attempting to connect to the network.

As indicated, the classes of client devices may be defined by the device manufacturer. Thus, a class of client device may be, for example, Microsoft® Windows® devices; Apple® devices, including laptops, tablets and/or phones, Google® Android® devices, including tablets and/or phones, among others. Once the class of the client device connecting to a network is identified, the client device is given a usable IP address to connect to the network only if that particular class of client device is designated by the network owner or operator as allowed to connect to the network. Alternatively, if that particular class of client device is not allowed to connect to the network, the client device is given an IP address and static route leading to a webpage to inform the user of the client device that connecting to the network is prohibited.

The present specification also describes a computer program product for managing access to a network that includes computer-readable instructions on a non-transitory medium, that, when executed by a processor, cause: presentation of a user interface including options to designate by device class, one or more classes of device to which network access will be allowed, the user interface listing a plurality of device classes for designation by a user; and granting or refusing access to the network based, at least in part, on whether a device requesting access belongs to the one or more classes designated. As used herein, a “non-transitory” medium is a storage medium excluding signals and other transitory media per se. However, volatile memory devices are non-transitory media.

Thus, a network may limit the number of client devices connecting to a network by class. By limiting the number of client devices connecting to a network by class, the network is less likely to be filled to capacity and overburdened. Thus, legitimate users can connect to the network without experiencing congestion and poor performance

As used in the present specification and in the appended claims, the term “class” refers broadly to distinctions between different types of client device. For example, as indicated above, the class of a device may be determined by whether it was manufactured by a particular group, organization, entity, or company. For example, as stated above, classes for client devices may be, for example, Microsoft® Windows® devices; Apple® devices, including laptops, tablets and/or phones; Google® Android® devices, including tablets and/or phones, among others.

Further, as used in the present specification and in the claims, the term “a number of” or similar language is meant to be understood broadly as any positive number comprising 1 to infinity; zero not being a number, but the absence of a number.

As will be described in detail below, an illustrative method for managing access to a network includes presenting, in a user interface of a computer on the network, options to designate by device class, one or more classes of device to which network access will be allowed. The method then includes allowing or denying access to the network based, at least in part, on whether a device requesting access belongs to said one or more classes designated. This may be done using a dynamic host configuration protocol (DHCP) server on said network,

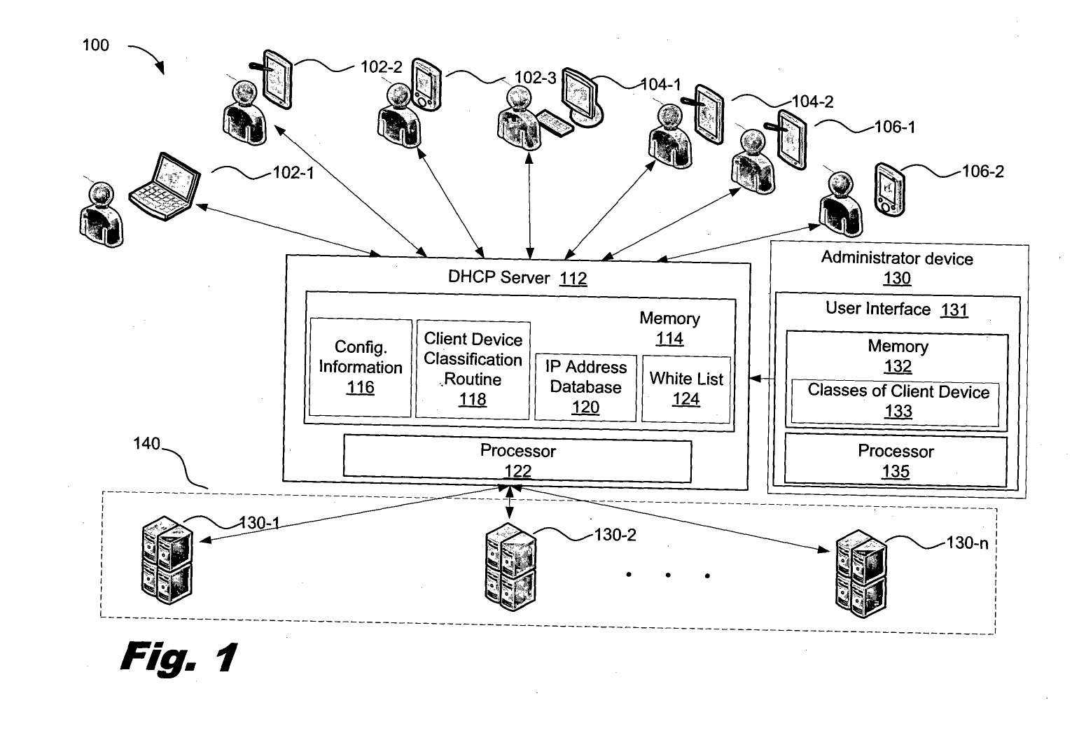

Referring now to the figures, FIG. 1 is a system illustrating a number of classes of client devices connecting to a network, according to one example of principles described herein. As mentioned above, filling a network to capacity or overfilling the network should be avoided by limiting the number of client devices connecting to the network. A network having too many client devices connected to the network could become overburdened thereby resulting in poor performance.

As illustrated, the system (100) includes a number of client devices (102 to 106) connecting, or attempting to connect, to a network (140). The network may include a number of servers (130-1, 130-2, 130-n) for providing services to the client devices (102 to 106).

For illustrative purposes, the client devices (102 to 106) may be categorized into a number of classes. For example, one class of client devices (102 to 106) includes devices (102) from Manufacturer X (102), such as a notebook computer (102-1), a tablet computer (102-2), or a smartphone (102-3). A class may include all devices by a particular manufacturer or just one particular model or collection of models of that manufacturer's devices. Any number of other classes of client devices may be utilized.

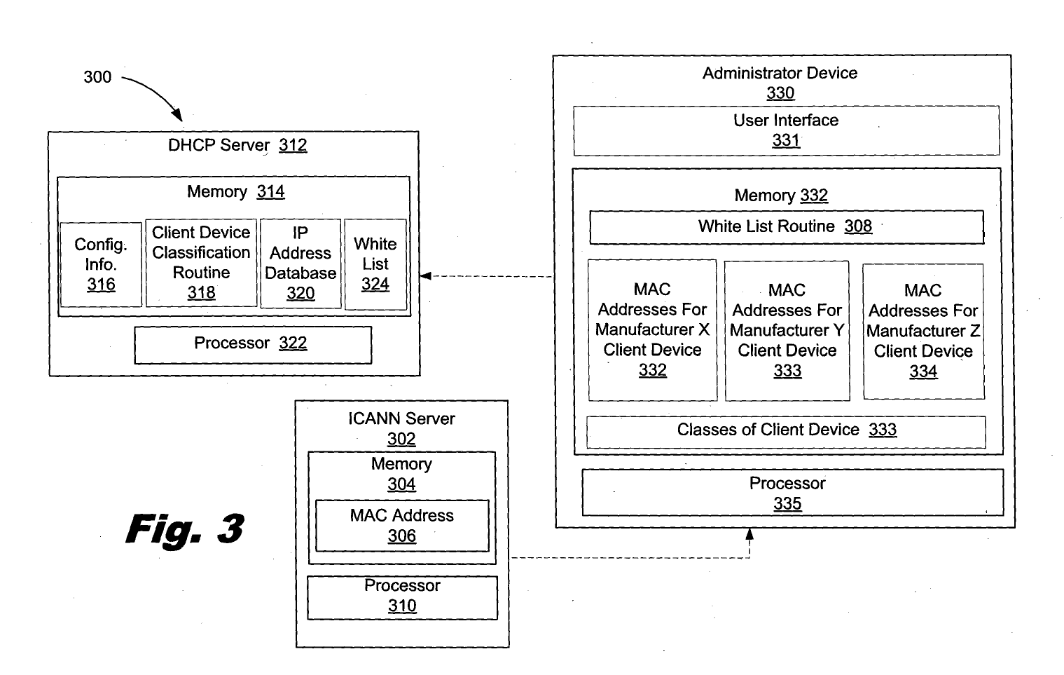

As noted above, a DHCP server (112) determines which client devices (102 to 106) should be given a usable IP address based on the device's class. A DHCP server (112) maintains an IP address database (120) of available IP addresses and configuration information (116). Further, the DHCP′ server (112) uses a DHCP network protocol to configure client devices (102 to 106) so that they can communicate on the network (140). Client devices (102 to 106) use the DHCP protocol to acquire configuration information (116), such as IP addresses stored in the IP address database (120) from the DHCP server (112). The DHCP server (112) then uses this information to configure client devices (102 to 106). Once the configuration process is complete, client devices (102 to 106) are able to communicate on a network (140). As disclosed herein, the DHCP server (112) maintains a white list (124) of valid ranges of MAC addresses for a number of classes of client devices (102 to 104) that may be given a usable IP address. The process of creating a white list is further detailed in FIGS. 3 to 6 and the corresponding text below.

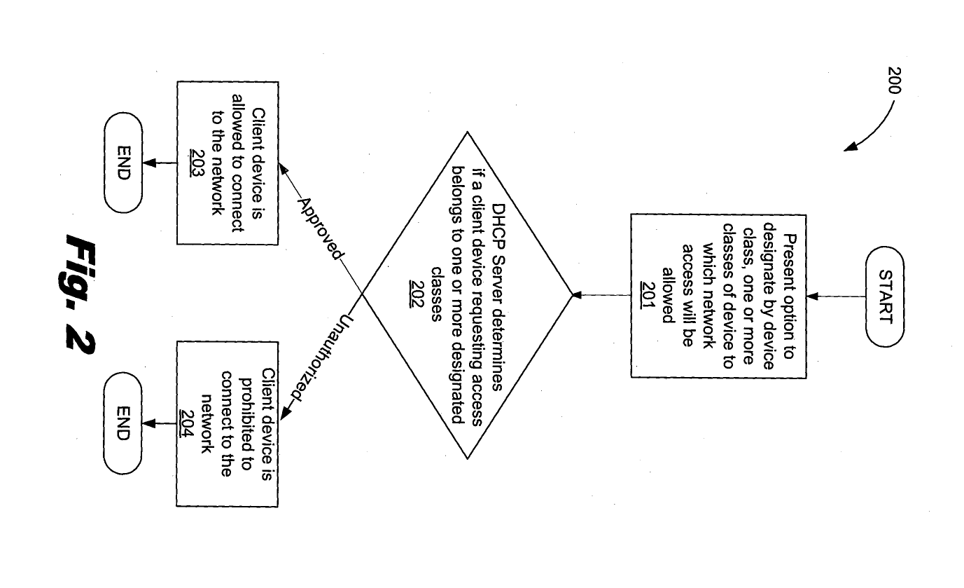

In one example, a client device classification routine (118) stored in memory (114) on a DHCP server (112) is used to limit the number of client devices (102 to 106) connecting to a network (140) based on the class of the client devices (102 to 106). The client device classification routine (118) and method to limit client devices (102 to 106) connecting to a network (140) based on the class of the client devices (102 to 106) is described in connection with FIG. 2 and FIG. 3 and in later sections of this specification.

In one example, an administrator device (130) uses a user interface (131) to present a network administrator with a list of one or more classes of client devices (133) that will be allowed to access a network (140). As will be described below, the network administrator selects one or more classes of client devices (133) that will be allowed to access a network (140). Consequently, the administrator does not need to know or consider what MAC addresses may correspond to permitted or excluded device classes.

In keeping with the current example, assume a network administrator selects only client devices (102) from Manufacturer X are allowed to access a network (140). Thus, only a class of client devices (102) from Manufacturer X may be given a useable IP address from the DHCP server's (112) IP address database (120) as determined by the client device classification routine (118). Thus, any devices (102) made by Manufacturer X is given a useable IP addresses and may connect to the network (140). Conversely, a device from any other class of client devices (104,106) such as, devices by some other manufacturer, are given an IP address and static route leading to a webpage to inform the user of that client device (104,106) that connecting to the network (140) is prohibited.

In yet another example, client devices from two or more different manufacturers may make up classes that are authorized to access a network. For example, assume a network administrator selects only client devices (102) from Manufacturer X and classes of client devices (104) from Manufacturer Y are allowed to access a network (140). Thus, all classes of client devices (102) by Manufacturer X and all classes of client devices (104) by Manufacturer Y are given usable IP addresses and may connect to a network (140). Consequently, any other classes of client devices such as, devices (106) made by Manufacturer Z, are given an IP address and static route leading to a webpage to inform the user of the client device (106) that connecting to the network (140) is prohibited. Any combination of classes of client devices (102 to 106) may be given a useable IP address from the DHCP server's (112) IP address database (120) as determined by the client device classification routine (118).

By limiting the number of client devices (102 to 106) being able to connect to a network (140) by class, fewer client devices (102 to 106) are able to connect to a network (140). Consequently, the network (140) is less likely to be filled to capacity and overburdened. Thus, the network (140) may avoid congestion and poor performance allowing legitimate users to better use the network (140).

FIG. 2 is a flowchart illustrating a method to manage access to a network, according to one example of principles described herein. As noted above, filling a network to capacity or overfilling a network should be avoided by limiting the number of client devices connecting to the network.

As mentioned in connection with FIG. 1, client devices (FIGS. 1, 102 to 106) are limited to connect to a network (FIG. 1, 140) by determining if a client device (FIGS. 1, 102 to 106) should be given a usable IP address to connect to a network (FIG. 1, 140) based on the class to which that device belongs. Limiting the number of client devices on a network allows legitimate users, such as a network owner, to connect to the network without experiencing congestion and poor performance.

As noted above, a DHCP server (FIG. 1, 112) stores a range of MAC addresses for the class of client devices (FIGS. 1, 102 to 106) allowed to connect to a network (FIG. 1, 140). Further, in order to categorize client devices (FIGS. 1, 102 to 106) into various classes based on a range of MAC addresses, MAC address could be divided into two parts. The first part, consisting of the first 6 digits, belongs to the vendor of the network card. The second part, consisting of the last 6 digits, specifies the interface serial number for that interface controller vendor. According to certain illustrative principles, the range of MAC addresses for devices by Manufacturer X (FIG. 1, 102) is different from the range of MAC addresses for devices by Manufacturer Y (FIG. 1, 104) or Manufacturer Z, etc. Thus, a white list (FIG. 1, 124) may be formed using a range of MAC addresses that identify any class or classes of client devices (FIGS. 1, 102 to 106) that are allowed to connect to a network (FIG. 1, 140).

While the examples given herein show classes of devices defined by manufacturer, other criteria may be used to delineate different device classes. Any criterion for distinguishing classes of devices falls within the scope of the present disclosure and claims.

Turning specifically to FIG. 2, options are presented (201) to designate by device class, one or more classes of device to which network access will be allowed. As mentioned above, an administrator device (FIG. 1, 130) uses a user interface (FIG. 1, 131) to present (201) a network administrator with a list of one or more classes of client devices (FIG. 1, 133) that will be allowed to access a network (140). To limit the number of client devices (FIGS. 1, 102 to 106) connecting to the network (FIG. 1, 140), the network administrator selects one or more classes of client devices (FIG. 1, 133) that will be allowed to access a network (FIG. 1, 140). As will be described in FIGS. 3 to 6, a range of MAC addresses corresponding to the selected classes of client devices (133) are uploaded to a DHCP server's (FIG. 1, 112) white list (FIG. 1, 124) to allow access to the network (FIG. 1, 140) for the selected classes of client devices.

Next, a DHCP Sever determines (201) the class of the client device. For example, if the MAC address of a client device falls within the range of approved MAC addresses, the DHCP server identifies (201) the class of the client device as approved and allows (202) the device to access the network. Alternatively, if the MAC address of a client device falls within the range of non-approved MAC addresses, the DHCP server identifies (201) the class of the client device as not approved or unauthorized. Consequently, the server denies (203) the device access to the network.

In one example, assume only client devices by Manufacturer X are allowed to connect to a network. Thus, the range or ranges of MAC address for Manufacturer X Client Devices are stored on a white list. If a client device by Manufacturer X is identified (201) connecting to the network, that client device is given a usable IP address by the DHCP server. Thus, the client device is allowed (202) to connect to the network.

Alternatively, if the class of client devices is not on the white list, the client device is not given a usable IP address by the DHCP server. Thus, the client device is prohibited (203) from connecting to the network.

Further, the DHCP server has a small pool of IP addresses and static routes that are allocated for such client devices. The small pool of IP addresses and static routes direct the unauthorized client devices to a webpage stating that access to the network is denied.

As mentioned above, the process of creating a white list is further detailed in FIGS. 3 to 6. In one example, a white list can be created by manually entering valid ranges of MAC addresses for each class of client device. Further, a human, perhaps a network administrator, may manually enter valid ranges of MAC addresses for each class of client device to create a white list. Manually entering valid ranges of MAC addresses for each class of client device to a white list is a burdensome task for network administrators. Further, manually entering valid ranges of MAC addresses for each class of client device to a white list can result in inaccuracies and delays for client devices to connect to a network. Thus, FIGS. 3 to 6 disclose systems and methods to maintain ranges of MAC addresses for a number of classes of client devices. As mentioned above, a class may include all devices by a particular manufacturer or just one particular model or collection of models of that manufacturer's devices. Any number of other classes of client devices may be utilized.

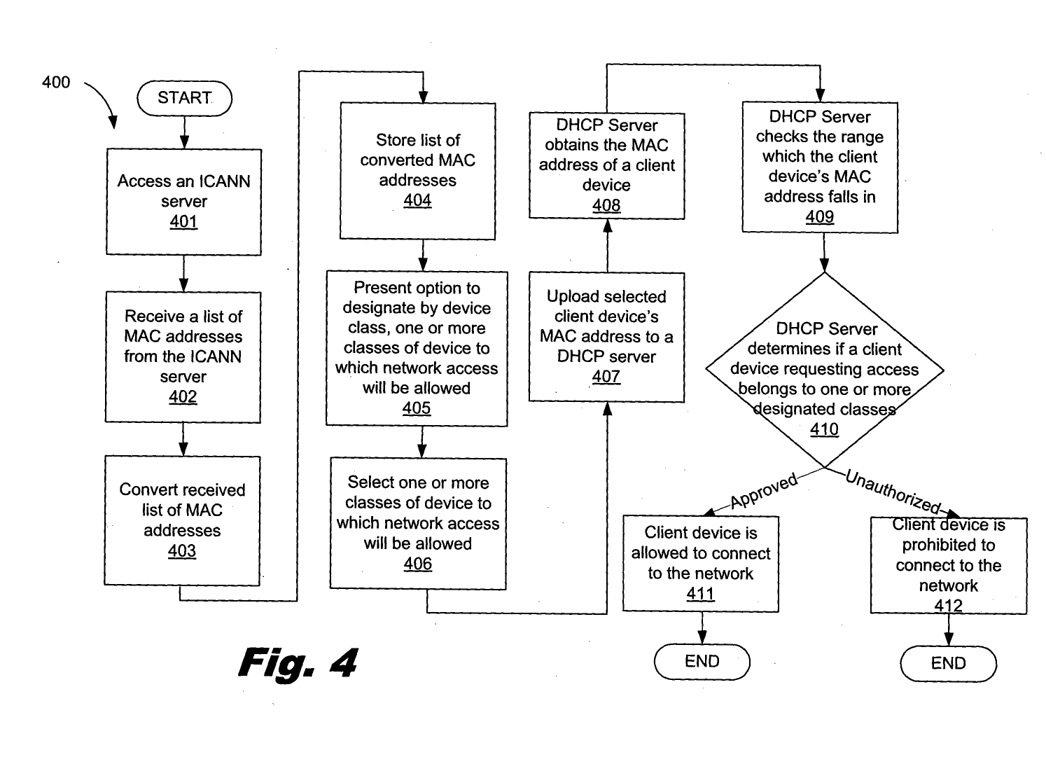

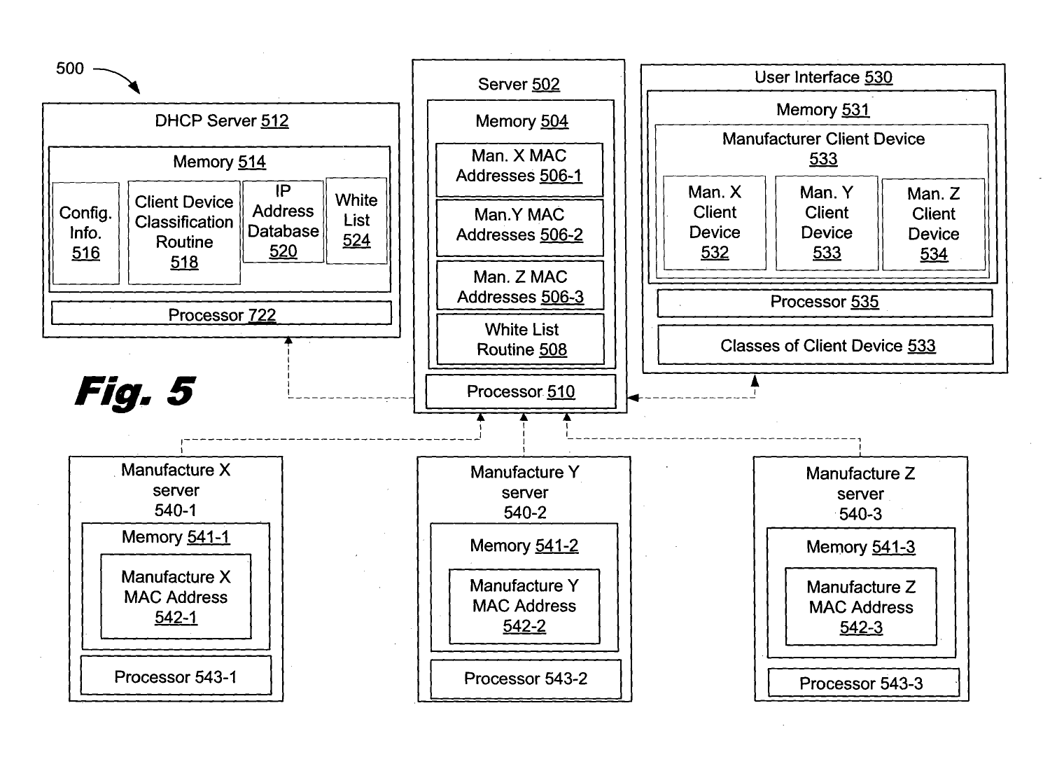

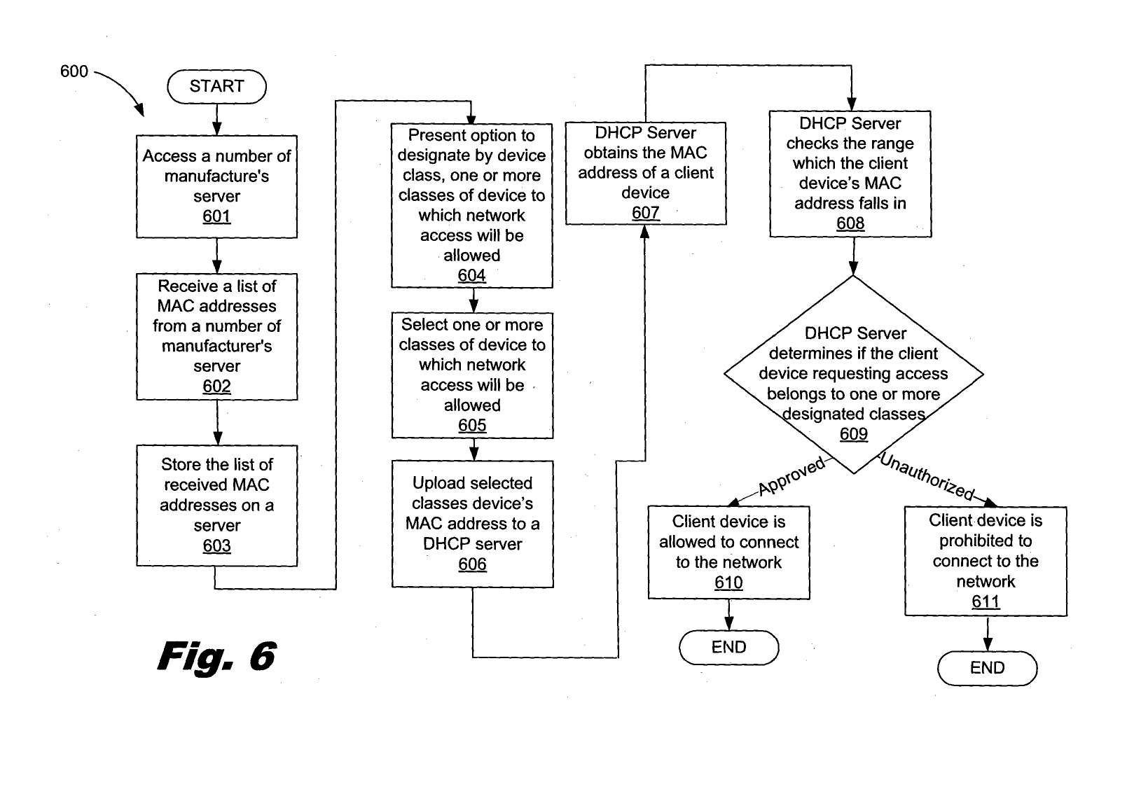

A system and method for creating a white list to limit client devices connecting to a network based on the class of the client device will now be described in connection with FIGS. 3 and 4. Further, an alternate system and method for creating a white list to limit client devices connecting to a network based on the class of the client device will be described in FIGS. 5 and 6.

FIG. 3 is a diagram illustrating a method using an Internet Corporation for Assigned Names and Numbers (ICANN) server to manage access to a network, according to one example of principles described herein. As mentioned above, a DHCP server (312) maintains a white list (324) of valid ranges of MAC addresses for a number of classes of client devices (FIGS. 1, 102 to 104) that may be given a usable IP address. If a class of client device (FIGS. 1, 102 to 104) is allowed to connect to a network, the DHCP server (312) sends configured information (316) and a usable IP address to the client device (FIGS. 1, 102 to 104). Alternatively, if a class of client device (FIGS. 1, 102 to 104) is denied access to the network based on the class of the client device, the DHCP server (312) sends an IP address to the client device that leads to a page indicating that access to the network is denied.

For a DHCP server (312) to maintain a white list (324) of valid ranges of MAC addresses for a number of classes of client devices (FIGS. 1, 102 to 104) allowed to connect to a network, the white list (324) is constantly updated in a consistent manner. If a white list (324) is constantly updated in a consistent manner, new client devices being released into a market can connect to a network.

In one example, an ICANN server (302) maintains a database of all MAC addresses (306) for all classes of client devices (FIGS. 1, 102 to 104). Further, the database of all the MAC address (306) is stored in memory on the ICANN server (302). Thus, each time a new client device is manufactured, the new client device's MAC address is uploaded to the ICANN server (306). According to certain principles, the MAC address (306) stored in memory on the ICANN server (302) is not in the same format used by a DHCP server (312). As will be described in FIG. 4, the white list routine (308) coverts the MAC address (306) stored in memory on the ICANN server (302) to a usable format for the DHCP server (312).

In one example, a white list routine (308) uses parsing techniques to convert the ICANN server's (302) MAC address (306) into a usable format for a DHCP server (312). Parsing the ICANN server's (302) MAC address (306) into a usable format for a DHCP server (312) may include categorizing client devices (FIGS. 1, 102 to 106) into various classes. Further, in order to categorize client devices (FIGS. 1, 102 to 106) into various classes based on a range of MAC addresses, MAC address could be divided into two parts. The first part, consisting of the first 6 digits, belongs to the vendor of the network card. The second part, consisting of the last 6 digits, specifies the interface serial number for that interface controller vendor. Thus, the white list routine (308) uses parsing techniques to categorize and convert the ICANN server's (302) MAC address (306) into a usable format for a DHCP server (312).

Further, an administrator device (330) uses a white list routine (308) to access an ICANN server (302) to receive a list of MAC addresses (306). The process of receiving the list of MAC addresses (306) using the white list routine (308) is described in detail in FIG. 4. As will be described in FIG. 4, the white list routine (308) classifies each MAC address (306) according to a class of the client device, for example by manufacturer. In one example, the administrator device (330) stores MAC addresses for Manufacturer X's client device (332), MAC addresses for Manufacturer Y's client device (333), and MAC addresses for Manufacturer Z's client device (334) in memory (332).

In keeping with the given example, an administrator device (330) uses a user interface (331) to present a network administrator with a list of one or more classes of client devices (333) that will be allowed to access a network (FIG. 1, 140). The network administrator selects a number of classes of client devices allowed to access a network. As will be described in FIG. 4, the MAC addresses for the selected classes of client devices allowed to access a network are uploaded to a DHCP server (312) to form a white list (324). In one example, assume the network administrator selects client devices (FIG. 1, 102) for Manufacturer X. Thus, only client devices (FIG. 1, 102) for Manufacturer X are allowed to access the network (FIG. 1, 140). In another example, assume the network administrator selects client devices (FIG. 1, 104) for Manufacturer Y and client devices (FIG. 1, 106) for Manufacturer Z. Thus, only client devices (FIG. 1, 104) for Manufacturer Y and client devices (FIG. 1, 106) for Manufacturer Z are allowed to access the network (FIG. 1, 140).

Turning specifically to FIG. 4, FIG. 4 is a flowchart illustrating a method to manage access to a network, according to one example of principles described herein. The method includes accessing (401) an ICANN server. As mentioned above, the ICANN server (FIG. 3, 302) includes MAC (FIG. 3, 306) for a number of client devices.

Next, the administrator device receives (401) a list of MAC addresses from the ICANN server. As mentioned above, the MAC address (FIG. 3, 306) stored in memory on the ICANN server (FIG. 3, 302) is not in the same format used by a DHCP server (FIG. 3, 312). Thus, the list of MAC address stored in memory on the ICANN server is converted (403) to a usable format for the DHCP server. As described above, converting (403) a list of MAC address stored in memory on the ICANN server (FIG. 3, 306) to a usable format for the DHCP server (FIG. 3, 312) includes parsing the list of MAC addresses (FIG. 3, 306). Next, the converted list of MAC addresses is stored (404) on an administrator device. In another example, the converted list of MAC addresses is stored (404) on a server. Thus, the converted list of MAC addresses is now in a usable format for the DHCP server (FIG. 3, 312). Next, a network administrator is presented (405) options to designate by device class, one or more classes of device to which network access will be allowed. As mentioned above, an administrator device (FIG. 1, 130) uses a user interface (FIG. 1, 131) to present (405) a list of one or more classes of client devices (FIG. 1, 133) that will be allowed to access a network (140).

In one example, to limit the number of client devices (FIGS. 1, 102 to 106) connecting to a network (FIG. 1, 140), a network administrator selects (406) one or more classes of client devices (FIG. 1, 133) that will be allowed to access a network (FIG. 1, 140). In keeping with the given example, assume the network administrator selects client devices (FIG. 1, 102) for Manufacturer X. In another example, assume the network administrator selects client devices (FIG. 1, 104) for Manufacturer Y and client devices (FIG. 1, 106) for Manufacturer Z. As will be described below, only the selected client devices are allowed to access a network.

Next, the selected client device's MAC addresses are uploaded (407) to a DHCP server. As mentioned above, a DHCP server (412) maintains a white list (424) of valid ranges of MAC addresses for a number of classes of client devices (FIGS. 1, 102 to 104) that may be given a usable IP address. If a class of client device (FIGS. 1, 102 to 104) is allowed to connect to a network, the DHCP server (412) sends configured information (416) and a usable IP address to the client device (FIGS. 1, 102 to 104). Alternatively, if a class of client device (FIGS. 1, 102 to 104) is denied access to the network based on the class of the client device, the DHCP server (412) sends an IP address to the client device that leads to a page indicating that access to the network is denied.

In keeping with the given example above, if a network administrator selects (406) client devices (FIG. 1, 102) for Manufacturer X. The MAC addresses for Manufacturer X (FIG. 3, 332) are uploaded (407) to the DHCP server (FIG. 3, 312) and are stored in the white list (FIG. 3, 324). Thus, only client devices (FIG. 1, 102) for Manufacturer X are allowed to access the network as will be described below.

In another example, assume the network administrator selects client devices (FIG. 1, 104) for Manufacturer Y and client devices (FIG. 1, 106) for Manufacturer Z. The MAC addresses for Manufacturer Y (FIG. 3, 333) and Manufacturer Y (FIG. 3, 334) are uploaded (407) to the DHCP server (FIG. 3, 312) and are stored in the white list (FIG. 3, 324). Thus, only client devices (FIG. 1, 104) for Manufacturer Y and client devices (FIG. 1, 106) for Manufacturer Z are allowed to access the network.

Thus, a range of MAC addresses corresponding to the selected classes of client devices are uploaded (407) to a DHCP server's (FIG. 3, 312) white list (FIG. 3, 324) to allow access to the network (FIG. 1, 140) for the selected classes of client devices. Thus, a white list is created to allow only the selected classes of client devices to connect to a network.

To manage the class of client devices connecting to a network, a DHCP server obtains (408) the MAC address of a client device when the DHCP server gets a request from the client device to connect to the network. Next, the DHCP server checks (409) the range in which the client device's (FIGS. 1, 102 to 106) MAC address falls. As noted in FIG. 2, the range of MAC addresses for client devices by Manufacturer X is different from the range of MAC addresses for client devices by other manufacturers. Consequently, the DHCP server determines (410) if a client device requesting access belongs to one or more designated classes. As mentioned above, the class of the client device can be based on the MAC address of the client device.

If the MAC address of a client device falls within the range indicated as authorized to access the network, the DHCP server determines (410) the class of the client device (FIG. 1, 102) as approved. Thus, the client device is allowed (411) to connect to the network. Further, if the MAC address of a client device falls within a range indicated as unauthorized, the DHCP server determines (410) the class of the client device as unauthorized. Thus, the client device is prohibited (412) to connect to the network. As indicated, the range of MAC address for each approved class of client device allowed to connect to a network is stored on a white list on the DHCP server or elsewhere.

As noted above, if a class of client devices is on the white list, those client devices are given a usable IP address by the DHCP server. Thus, those client devices are allowed to connect to the network.

Alternatively, if the class of client devices is not on the white list, those client devices are not given a usable IP address by the DHCP server. Thus, those client devices are prohibited (412) from connecting to the network. In these cases, the DHCP server has a small pool of IP addresses and static routes that are allocated for such client devices. The small pool of IP addresses and static routes direct the client devices (FIGS. 1, 104 to 106) to a webpage stating access to the network is not allowed.

Thus, by limiting the number of client devices (FIG. 1, 102) being able to connect to a network (FIG. 1, 140) by class, fewer client devices (FIG. 1, 102) are able to connect to a network (FIG. 1, 140). Consequently, the network (FIG. 1, 140) is not filled to capacity and not overburdened. Thus, the network (FIG. 1, 140) does not experience congestion and poor performance allowing legitimate users to connect to the network (FIG. 1, 140).

An alternate method for creating a white list to limit client devices connecting to a network based on the class of the client device will now be described in connection with FIGS. 5 and 6.

FIG. 5 is a diagram illustrating a method using a server to manage access to a network, according to one example of principles described herein. As mentioned above, a DHCP server (512) maintains a white list (524) of valid ranges of MAC addresses for a number of classes of client devices (FIGS. 1, 102 to 104) that may be given a usable IP address. If a class of client device (FIGS. 1, 102 to 104) is allowed to connect to a network, the DHCP server (512) sends configured information (516) and a usable IP address to the client device (FIGS. 1, 102 to 104). Alternatively, if a class of client device (FIGS. 1, 102 to 104) is denied access to the network based on the class of the client device, the DHCP server (512) sends an IP address to the client device that leads to a page indicating that access to the network is denied.

Further, for a DHCP server (512) to maintain a white list (524) of valid ranges of MAC addresses for a number of classes of client devices (FIGS. 1, 102 to 104) allowed to connect to a network, the white list (524) is constantly updated in a consistent manner. If a white list (524) is constantly updated in a consistent manner, new client devices being released into a market can connect to a network.

In one example, a server (502) uses a white list routine (508) to receive a list of MAC addresses (542) from a number of manufacturer's servers (540). The process of retrieving a number of MAC addresses from a number of manufacturer's servers (540) is described in detail in FIG. 6 and in corresponding sections below.

In one example, assume a number of manufacturer's servers (540) include MAC addresses (542) for each client device manufactured by each manufacturer. For example, assume three manufacturers manufacture client devices namely, Manufacturer X, Manufacturer Y, and Manufacturer Z. Further, assume Manufacturer X uses a server (540-1) to store its client device's MAC addresses (542-1). Further, assume Manufacturer Y uses a server (540-2) to store its client device's MAC addresses (542-2). Further, assume Manufacturer Z uses a server (540-3) to store its client device's MAC addresses (542-3). As will be described below, a white list routine (508) is used to receive a list of MAC addresses (542) from each manufacturer's servers (540).

In one example, the list of MAC addresses (506) from each manufacturer's server (542) is received and stored on a server (502) according to the client device's manufacturer. For example, Manufacture X MAC addresses (542-1), stored on Manufacturer X's server (540-1), are received and are stored in the server's (502) Manufacturer X MAC address database (506-1). Manufacture Y MAC addresses (542-2) stored on Manufacturer Y's server (540-2), are received and are stored in the server's (502) Manufacturer Y MAC address database (506-2). Manufacturer Z's MAC addresses (542-3), stored on Manufacturer Z's server (540-3), and are received and are stored in the server's (502) Manufacturer Z MAC address database (506-3). Thus, the server includes a valid range of MAC addresses for each manufacturer.

In keeping with the given example, a network administrator selects a one or more of classes of client devices allowed to access a network using an administrator device (530) as noted above. As will be described in FIG. 6, the MAC addresses for the selected classes of client devices allowed to access a network is uploaded to a DHCP server (512) to form a white list (524). In one example, assume the network administrator selects Manufacturer X client devices (532). As will be described below, only client devices X (FIG. 1, 102) for Manufacturer X are allowed to access the network. In another example, assume the network administrator selects Manufacturer Y client devices (533) and Manufacturer Z client devices (534). As will be described below, only client devices (FIG. 1, 104) for Manufacturer Y and client devices (FIG. 1, 106) for Manufacturer Z are allowed to access the network.

FIG. 6 is a flowchart illustrating a method to manage access to a network, according to one example of principles described herein. According to certain principles, the method includes accessing (601) a number of manufacturer's servers. Next, the server receives (602) a list of MAC addresses from a number of manufacturer's servers. Next, the received list of MAC addresses from each manufacturer's server is stored (603) on a server according to the client device's manufacturer. For example, Manufacture X MAC addresses (642-1), stored on Manufacturer X's server (640-1), are received and are stored in the server's Manufacturer X MAC address database (606-1). Manufacture Y MAC addresses (642-2), stored on Manufacturer Y's server (640-2), are received and are stored in the server's Manufacturer Y MAC address database (606-2). Manufacture Z's MAC addresses (642-3), stored on Manufacturer Z's server (640-3), are received and stored in the server's Manufacturer Z MAC address database (606-3). Thus, the server (FIG. 5, 502) includes a valid range of MAC addresses for each manufacturer.

Next, options are presented (604) to designate by device class, one or more classes of device to which network access will be allowed. As mentioned above, an administrator device (FIG. 1, 130) uses a user interface (FIG. 1, 131) to present (604) a network administrator with a list of one or more classes of client devices (FIG. 1, 133) that will be allowed to access a network (140).

In one example, to limit the number of client devices (FIGS. 1, 102 to 106) connecting to a network (FIG. 1, 140), a network administrator selects (605) one or more classes of client devices (FIG. 1, 133) that will be allowed to access a network (FIG. 1, 140). In keeping with the given example, assume the network administrator selects client devices (FIG. 1, 102) for Manufacturer X. In another example, assume the network administrator selects client devices (FIG. 1, 104) for Manufacturer Y and client devices (FIG. 1, 106) for Manufacturer Z. As will be described below, only the selected client devices are allowed to connect to a network.

Next, a number of selected client device's MAC addresses are uploaded (606) to a DHCP server. As mentioned above, a DHCP server (FIG. 5, 512) maintains a white list (FIG. 5, 524) of valid ranges of MAC addresses for a number of classes of client devices (FIGS. 1, 102 to 104) that may be given a usable IP address. If a class of client device (FIGS. 1, 102 to 104) is allowed to connect to a network, the DHCP server (FIG. 5, 512) sends configured information (FIG. 5, 516) and a usable IP address to the client device (FIGS. 1, 102 to 104). Alternatively, if a class of client device (FIGS. 1, 102 to 104) is denied access to the network based on the class of the client device, the DHCP server (FIG. 5, 512) sends an IP address to the client device that leads to a page indicating that access to the network is denied.

In keeping with the given example above, if the network administrator selects (605) client devices (FIG. 1, 102) for Manufacturer X. The MAC addresses for Manufacturer X (FIG. 3, 332) are uploaded (606) to the DHCP server (FIG. 5, 512) and are stored in the white list (FIG. 5, 524). Thus, only client devices (FIG. 1, 102) for Manufacturer X are allowed to access the network as will be described below.

In another example, assume the network administrator selects client devices (FIG. 1, 104) for Manufacturer Y and client devices (FIG. 1, 106) for Manufacturer Z. The MAC addresses for Manufacturer Y (FIG. 5, 533) and Manufacturer Y (FIG. 5, 534) are uploaded (606) to the DHCP server (FIG. 5, 512) and are stored in the white list (FIG. 5, 524). Thus, only client devices (FIG. 1, 104) for Manufacturer Y and client devices (FIG. 1, 106) for Manufacturer Z are allowed to access the network.

Thus, a range of MAC addresses corresponding to the selected classes of client devices are uploaded (606) to a DHCP server's (FIG. 5, 512) white list (FIG. 5, 524) to allow access to the network (FIG. 1, 140) for the selected classes of client devices. Thus, a white list is created to allow only the selected classes of client devices to connect to a network.

To limit the class of client devices connecting to a network, a DHCP server obtains (607) the MAC address of a client device when the DHCP server gets a request from the client device to connect to the network. Next, the DHCP server checks (608) the range in which the client device's (FIGS. 1, 102 to 106) MAC address falls. As noted in FIG. 2, the range of MAC addresses for client devices by Manufacturer X is different from the range of MAC addresses for client devices by other manufacturers. Consequently, the DHCP server determines (609) if a client device requesting access belongs to one or more designated classes. As mentioned above, the class of the client device can be based on the MAC address of the client device.

If the MAC address of a client device falls within the range indicated as authorized to access the network, the DHCP server determines (609) the class of the client device (FIG. 1, 102) as approved. Thus, the client device is allowed (610) to connect to the network. Further, if the MAC address of a client device falls within a range indicated as unauthorized, the DHCP server determines (609) the class of the client device as unauthorized. Thus, the client device is prohibited (611) to connect to the network. As indicated, the range of MAC address for each approved class of client device allowed to connect to a network is stored on a white list on the DHCP server or elsewhere.

As noted above, if a class of client devices is on the white list, those client devices are given a usable IP address by the DHCP server. Thus, those client devices are allowed to connect to the network.

Alternatively, if the class of client devices is not on the white list, those client devices are not given a usable IP address by the DHCP server. Thus, those client devices are prohibited (611) from connecting to the network. In these cases, the DHCP server has a small pool of IP addresses and static routes that are allocated for such client devices. The small pool of IP addresses and static routes direct the client devices (FIGS. 1, 104 to 106) to a webpage stating access to the network is not allowed.

Thus, by limiting the number of client devices (FIG. 1, 102) being able to connect to a network (FIG. 1, 140) by class, fewer client devices (FIG. 1, 102) are able to connect to a network (FIG. 1, 140). Consequently, the network (FIG. 1, 140) is not filled to capacity and not overburdened. Thus, the network (FIG. 1, 140) does not experience congestion and poor performance allowing legitimate users to connect to the network (FIG. 1, 140).

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for managing access to a network, the method comprising:
presenting, by a user interface of a computer on said network, an option to designate, by device class, one or more classes of device to which network access will be allowed; and
with a dynamic host configuration protocol (DHCP) server on said network, allowing or denying access to said network based at least in part on whether a device requesting access belongs to said one or more classes designated.

2. The method of claim 1, wherein a class to which said device requesting access belongs is determined by a Media Access Control (MAC) address of that device, said method further comprising allowing the requesting device to connect to the network only if the MAC address of the requesting device falls within a range of MAC addresses designated as approved for access to the network.

3. The method of claim 1, wherein a class of a device requesting access to said network is based on a manufacturer of that device, such that devices from different manufacturers are of different classes for purposes of accessing said network.

4. The method of claim 3, further comprising:
receiving, from one or more manufacturers of network devices, a listing of Media Access Control (MAC) addresses used by those manufacturers; and
with said DHCP server, using said listing of MAC addresses to determine a class of a device requesting access to said network.

5. The method of claim 1, further comprising:
receiving, from a server operated by Internet Corporation for Assigned Names and Numbers (ICANN), a listing of Media Access Control (MAC) addresses that have been assigned to specific device manufacturers; and
converting said listing into instructions for said DHCP server such that said DHCP server matches a MAC address of a device requesting access to a network with a manufacturer of that device to determine a class of that device.

6. The method of claim 1, wherein allowing the requesting device to connect to the network based on the class of the device comprises sending configured information and a usable Internet Protocol (IP) address to the requesting device.

7. The method of claim 1, wherein denying access to the network based on the class of the requesting device comprises sending an internet protocol (IP) address to the requesting device that leads to a page indicating that access to the network is denied.

8. A system for managing access to a network, the system comprising:
an administrator device comprising a user interface presenting options to designate by device class, one or more classes of device to which network access will be allowed; and
a dynamic host configuration protocol (DHCP) server in communication with said administrator device for allowing or denying access to said network based, at least in part, on whether a device requesting access belongs to said one or more classes designated.

9. The system of claim 8, wherein a class to which said device requesting access belongs is determined by a Media Access Control (MAC) address of that device.

10. The system of claim 8, wherein a class of a device is based on a manufacturer of that device, such that devices from different manufacturers are of different classes for purposes of accessing said network.

11. The system of claim 8, further comprising:
an interface between said DHCP server and data systems for one or more manufacturers of network devices for downloading to said DHCP server a listing of Media Access Control (MAC) addresses that have adopted by those manufacturers.

12. The system of claim 8, further comprising:
an interface between said DHCP server and a server operated by Internet Corporation for Assigned Names and Numbers (ICANN) for downloading to said DHCP server a listing of Media Access Control (MAC) addresses that have been assigned to specific device manufacturers.

13. A computer program product for managing access to a network, said product comprising computer-readable instructions on a non-transitory medium, said instructions, when executed by a processor, causing:
presentation of a user interface including options to designate by device class, one or more classes of device to which network access will be allowed, said user interface listing a plurality of device classes for designation by a user; and
granting or refusing access to said network based, at least in part, on whether a device requesting access belongs to said one or more classes designated.

14. The product of claim 13, wherein, when granting network access, said instructions cause transmission of configuration information and a usable Internet Protocol (IP) address to the requesting device.

15. The product of claim 13, wherein, when refusing network access, said instructions cause transmission of an Internet protocol (IP) address to the requesting device that leads to a page indicating that access to the network is refused.
